(19) United States
(12) Patent Application Publication
(10) Pub. No.: US 2025/0030185 A1
(43) Pub. Date: Jan. 23, 2025

(54) ELECTRICAL CONTACT ELEMENT, PRE-ASSEMBLED ELECTRICAL CABLE AND MANUFACTURING METHOD

(71) Applicant: Rosenberger Hochfrequenztechnik GmbH & Co. KG, Fridolfing (DE)

(72) Inventor: Andreas FISCHER, Fridolfing (DE)

(21) Appl. No.: 18/677,238

(22) Filed: May 29, 2024

(30) Foreign Application Priority Data
Jul. 19, 2023 (EP) 23 186 490.1

(51) Int. Cl. H01R 11/11; H01R 4/18; H01R 43/16

(52) U.S. Cl. CPC H01R 11/11; H01R 4/184; H01R 43/16

(57) ABSTRACT

An electrical contact element (3) is formed from a stamped and bent part and/or from a deep-drawn metal component (1). The electrical contact element (3) has a contact area (6) having an end-face contact surface (7) designed for electrical and mechanical contacting with an electrical mating contact element. The electrical contact element (3) also has a support area (8), which is arranged on a side of the contact area (6) facing away from the end-face contact surface (7) and is designed so as to mechanically support the contact area (6). It is provided that the contact area (6) is integrally connected to the support area (8) via a primary connecting section (9).

### CROSS-REFERENCE TO RELATED APPLICATION

This application claims the benefit and priority of European Patent App. Ser. No. 23 186 490.1 filed on Jul. 19, 2023, the entire disclosure of which is incorporated herein by reference.

### BACKGROUND OF THE INVENTION

### 1. Field of the Invention

The invention relates to an electrical contact element which is formed from a stamped and bent part or from a deep-drawn metal component, according to the preamble of claim 1.

Furthermore, the invention relates to a pre-assembled electrical cable comprising an electrical conductor and an electrical contact element that is electrically and mechanically connected to the electrical conductor.

The invention also relates to a manufacturing method for manufacturing an electrical contact element or a pre-assembled electrical cable.

### 2. Related Art

Electrical contact elements for directly contacting corresponding electrical mating contact elements are known in electrical engineering for a variety of applications. Electrical contact elements and corresponding mating contact elements are used inter alia in electrical plug connectors or electrical mating plug connectors for direct electrical and mechanical contacting. Different types of contacting are possible for this.

In addition to contact elements which make radial contact with the corresponding mating contact element (for example pin contacts that are contacted on their outer surfaces by spring contact tabs), contact elements based on an end-face contact are also used in particular. One possible variant of such an end-face contact element is disclosed, by way of example, in DE 10 2021 122 611 A1.

High demands are sometimes placed on the robustness of plug connectors and their contact elements. In particular a contact element must be suitable at the most for a very high number of mating cycles. In order to fulfill these requirements, end-face contact elements are usually designed as solid volume bodies and consequently generally as turned parts.

In addition to the robustness or durability of the contact elements, a further common requirement is to manufacture the contact elements economically in large quantities. However, the manufacture of the known end-face contact elements is associated with considerable material, production and assembly costs. The weight of the known end-face contact elements, in particular if these are designed as solid turned parts, is also not insignificant.

### SUMMARY OF THE INVENTION

In view of the known prior art, the object of the present invention is to provide an electrical contact element which can be manufactured cost-effectively, in particular within the scope of mass production, and which is advantageously suitable for end-face contacting, preferably with high mechanical stability.

The object of the present invention is also to provide an electrical cable that is pre-assembled with an electrical contact element and which can be manufactured cost-effectively, in particular within the scope of mass production, and which is advantageously suitable for end-face contacting, preferably with high mechanical stability.

Furthermore, it is the object of the invention to provide a manufacturing method with which an electrical end-face contact element or an electrical cable pre-assembled therewith can be manufactured cost-effectively, in particular within the scope of mass production, preferably with high mechanical stability.

The object is achieved for the electrical contact element with the features disclosed in claim 1. With regard to the pre-assembled electrical cable, the object is achieved by the features of claim 14. With regard to the manufacturing method, the object is achieved by claim 15.

The dependent claims and the features described below relate to advantageous embodiments and variants of the invention.

An electrical contact element is provided, which is formed from a stamped and bent part and/or from a deep-drawn metal component.

The electrical contact element can be formed in particular by stamping and subsequent or simultaneous bending of a metal component (usually a primarily flat metal component, in particular a metal sheet) or by deep drawing of a corresponding metal component. A combination of the two manufacturing processes, i.e. stamping/bending and preceding, simultaneous or subsequent deep-drawing of areas of the metal component, can also be provided.

Preferably, the electrical contact element consists exclusively of the stamped and bent part or the deep-drawn metal component and has no other components. The electrical contact element is therefore preferably formed integrally or monolithically, particularly preferably from an originally primarily flat metal component/metal sheet.

Stamping and bending processes and deep-drawing processes are sufficiently well known in the prior art, which is why no further details are provided here. Both manufacturing processes are particularly suitable for the cost-effective manufacture of components for plug connectors within the scope of mass production, but are, according to the relevant opinion of experts, rather unsuitable for the manufacture of end-face contact elements due to their lack of mechanical stability.

According to the invention, the proposed electrical contact element has a contact area having an end-face contact surface designed for electrical and mechanical contacting with an electrical mating contact element.

The electrical contact element is thus advantageously designed for end-face contacting and can therefore also be referred to as an “end-face contact element”.

The mating contact element can also be designed as an end-face contact element, for example as a pin contact element, in particular as a spring-loaded pin contact element.

Preferably, the proposed contact element is a primarily elongated component that extends along a center or longitudinal axis. The longitudinal axis preferably also runs along the contacting direction of the contact element with the corresponding mating contact element.

The contact area is preferably an end section of the contact element that is at the front along the longitudinal axis or contacting direction and faces the mating contact element. The contact area can extend starting from the front end of the contact element along the longitudinal axis in the direction of the rear end of the contact element facing away from the mating contact element.

The end-face contact surface of the contact area is formed in particular at the front end of the electrical contact element and faces the electrical mating contact element.

According to the invention, the electrical contact element also has a support area, which is arranged on a side of the contact area facing away from the end-face contact surface and is designed so as to mechanically support the contact area. The contact area is integrally or monolithically connected to the support area via a primary connecting section.

The support area is arranged behind the contact area along the longitudinal axis of the electrical contact element, preferably starting from the front end of the contact element. The support area is preferably directly adjacent to the contact area along the longitudinal axis of the contact element.

By combining a contact element designed as a stamped and bent part and/or as a deep-drawn component with the aforementioned support area for the end-face contact area, it is advantageously possible to realize an end-face contact element that can be produced particularly cost-effectively within the scope of mass production, but which nevertheless has a high mechanical stability. In this way, considerable material and assembly costs as well as weight for the electrical contact element can be saved without negatively affecting the service life or mechanical stability of the contact element in practice.

The end-face contact surface can preferably be circular or round. However, alternative surface geometries are also possible (for example a rectangular or square surface, an elliptical surface, a polygonal surface, etc.).

In an advantageous development of the invention, it can be provided that the end-face contact surface is formed as a single, continuous surface.

In principle, however, the invention can also provide for the end-face contact surface to be formed from a plurality of individual segments or from a plurality of individual surfaces. The end-face contact surface can be divided, for example, into two parts and thus, for example, can be formed from two contact tabs that are bent towards each other. A three-part, four-part or even more divided end-face contact surface is also possible in principle.

However, a particularly high level of mechanical stability can be achieved if the end-face contact surface is continuous and preferably the entire contact area is monolithic or designed as a continuous area.

In principle, the end-face contact surface of the contact area can have any geometry or any contour. For example, the end-face contact surface can be convex or concave. A mating contact surface of the mating contact element can then preferably have a complementary design, so that contact can again be made between the contact element and the mating contact element primarily over any surface area.

According to a particularly preferred development of the invention, however, it can be provided that the end-face contact surface is a primarily flat surface.

However, the fact that the end-face contact surface is preferably a primarily flat surface is fundamentally not intended to exclude the possibility that one or more recesses (for example, the centering bore mentioned below) or elevations (for example, a centering point, for example an embossing introduced from the rear side of the end-face contact surface) are optionally formed in the mentioned flat surface. A mating contact surface of the mating contact element can preferably have a complementary structure, for example a complementary elevation or depression.

According to one development of the invention, it can be provided, for example, that one or more holes are formed in the end-face contact surface.

The bore or bores can preferably be a blind bore. However, through-holes can also be provided if necessary. The one or more holes can optionally have a chamfer or a transition radius to the end-face contact surface.

According to a preferred embodiment, the end-face contact surface can have exactly one central centering hole, for example to center the corresponding mating contact element and/or to ensure greater stability of the connection in the contacted state by means of a positive-locking connection in sections and/or to support a check of the correct assembly of the contact element within the scope of a plug connector assembly or cable assembly (for example in that the centering hole supports the centering of a mechanical test probe or in that the centering hole can be used as an optical detection aid for an optical check of the correct positioning and/or orientation of the contact element).

It is also possible to provide that the holes are designed so as to accommodate one or more permanent magnets. A contact element accordingly equipped with magnets can facilitate contacting with the mating contact element (for example enable “blind mating”) and/or provide magnetic coding so that contacting is only possible with certain mating contact elements and/or only in one or more predetermined orientations.

It should be mentioned at this point that it is also possible in principle for one or more mechanical coding means to be integrated in the end-face contact surface or in the contact area, so that contacting is only possible with certain mating contact elements and/or only in one or more predetermined orientations.

Optionally, a contour can also be formed on the end-face contact surface, for example a chamfer or rounding along the circumference of the end-face contact surface. A funnel-shaped molding of the end-face contact surface or the contact area can also be provided.

In one development of the invention, it can be provided that the support area is in part annular, annular or preferably at least essentially sleeve-shaped or hollow-cylindrical. In principle, however, the support area can be of any design in order to support the contact area on the rear side in sections or completely circumferentially. The support area can basically have any geometry, inter alia also a spiral-shaped or star-shaped geometry. The support area can also support the contact area at a position that is at a distance from the edges or sides (“further in” instead of directly along the outer circumference).

Preferably, an annular or in part annular end of the sleeve-shaped support area facing the contact area mechanically supports the contact area on the side facing away from the end-face contact surface.

In one development of the invention, it can be provided that the support area, in particular (but not exclusively) the sleeve-shaped support area, is formed from two support tabs or half shells that are bent towards each other.

Preferably, the support tabs or half shells that are bent towards each other touch each other with their ends facing each other at least in sections along the longitudinal axis of the contact element when fully bent. The support area is therefore preferably closed along the longitudinal axis of the contact element, at least essentially in the circumferential direction. In this way, a particularly stable support and a very high mechanical stability of the contact element can be achieved.

However, the support area can also be in part open in the circumferential direction, for example forming a U-shape or a V-shape.

In an advantageous development of the invention, it can be provided that the primary connecting section is designed as a bending point in order to form a transition angle between the support area and the contact area.

The transition angle can, for example, be 20° to 160°, preferably 45° to 135°, particularly preferably 80° to 100°, in particular at least approximately 90° or exactly 90°.

The end-face contact surface is therefore preferably oriented at least essentially orthogonally to the longitudinal axis of the electrical contact element. If necessary, however, the end-face contact surface can also be tilted relative to a perpendicular orientation, although this is less preferable.

Preferably, the longitudinal axis of the contact element runs centrally through the end-face contact surface.

In one development of the invention, it can be provided that the contact area is connected to the support area via at least one secondary connecting section.

The secondary connecting section is preferably spaced apart from the primary connecting section along the circumference of the end-face contact surface.

Whereas the contact area is integrally connected to the support area via the primary connecting section, it is preferable for the connection to be made in multiple parts via the secondary connecting section, preferably in a positive-locking, non-positive-locking and/or a material-bonded manner.

The secondary connecting section can be a further section of the contact area or of the support area that is different from the primary connecting section in order to further stabilize the mechanical connection between the contact area and the support area and thus further increase the overall mechanical stability of the electrical contact element. The at least one secondary connecting section in addition to the primary connecting section can advantageously prevent the contact area or the end-face contact surface from springing back during contacting.

In principle, any number of secondary connecting sections can be provided and distributed along the circumference of the end-face contact surface.

The at least one secondary connecting section can either be integrally or monolithically connected to the contact area or integrally or monolithically connected to the support area (the positive-locking, non-positive-locking and/or material-bonded connection can preferably be made to the respective other area). Insofar as a plurality of secondary connecting sections are provided, some of the secondary connecting sections can be connected if necessary to the contact area and other sections of the secondary connecting sections can be connected to the support area-it is therefore not necessary for all secondary connecting sections to be integrally connected to the same area. Optionally (less preferable), it can also be provided that the secondary connecting sections are neither integrally connected to the contact area nor integrally connected to the support area and are therefore designed as completely independent components.

In a particularly advantageous development of the invention, it can be provided that the secondary connecting section is designed as a connecting tab that is integrally connected to the contact area and is bent in the direction of the support area and connected to the support area along a longitudinal axis of the contact element at least in a positive locking manner.

The support area can form a corresponding positive-locking receptacle for the positive-locking connection to the secondary connecting section or to the connecting tab, in particular a receptacle which can be engaged behind by the bent-over connecting tab of the contact area along the longitudinal axis of the contact element in order to enable locking of the contact area to the support area along the longitudinal axis. The connecting tab or the secondary connecting section can be designed accordingly in order to enable latching along the longitudinal axis in such a recess, for example by the secondary connecting section or the connecting tab having a jump in diameter in the area of the free end section. The secondary connecting section or the connecting tab can be at least essentially T-shaped for this purpose, for example.

Preferably, therefore, it is possible to provide a connecting tab which is anchored on the end-face contact surface and is bent over and threaded in a positive-locking manner into a corresponding recess on the support area, so that the positive-locking connection prevents axial displacement of the end-face contact surface along the longitudinal axis of the contact element and thus prevents the contact area from springing inwards.

In an advantageous development of the invention, it can be provided that the connecting tab of the secondary connecting section is connected directly to the support area at the connection points of the two half shells.

In a particularly preferred embodiment, it can be provided that the connecting tab of the secondary connecting section forms a further positive-locking connection in the circumferential direction to the sleeve-shaped support area, so that the half shells of the support area are locked against each other.

In one development of the invention, it can be provided that the secondary connecting section has at least one welding or bonding point in order to connect the contact area to the support area.

As already mentioned, the connection of the secondary connecting section to the contact area or the support area can in principle be made in any way, wherein the positive-locking connection described above is preferred, since this enables particularly simple manufacturability. However, pressing, welding or bonding or any other connection technique are also possible in principle and can be realized within the scope of the present invention.

As a rule, it can be provided that the support area supports the contact area along the longitudinal axis of the contact element immovably or rigidly, i.e. inelastically. For many applications, a rigid support is generally sufficient.

In one development of the invention, however, it can also be provided that the support area supports the contact area along the longitudinal axis of the contact element in an elastically resilient manner.

It can therefore be provided that the contact element or the end-face contact surface of the contact element can spring back along the longitudinal axis of the contact element in the direction of the end of the contact element facing away from the mating contact element when it is connected to the mating contact element. Such a spring-loaded end-face contact can improve the electrical and mechanical connection during operation of the contact arrangement. In particular, high vibration resistance of the plug connection can be guaranteed. In addition, the risk of unintentional disconnection of the electrical and mechanical connection between the contact element and the mating contact element can be reduced and the contact resistance reduced.

The elasticity between the support area and contact area can be realized, for example, by a support area that is elastic at least in part along the longitudinal axis of the contact element and/or a primary connecting section that is elastic at least in sections and/or a secondary connecting section that is elastic at least in sections. For this purpose, the respective tabs can be formed inter alia in the shape of a band or in the manner of axially acting spring tabs (for example, have a correspondingly suitable width, length and/or material thickness). For example, the connecting tab of the secondary connecting section and/or a connecting tab of the primary connecting section can also be bent or buckled in sections in the direction of the longitudinal axis of the contact element in order to provide corresponding elasticity.

The connecting sections can be designed as lateral spring tabs. In this case in particular, it can be advantageous to connect at least one of the connecting sections, in particular the secondary connecting section, to the support surface and/or the contact area via an additional welding or bonding point in order to still enable simple manufacturability within the scope of a stamping and bending process.

In one development, it can be provided that the electrical contact element has a connection area for electrical and mechanical connection to an electrical conductor, in particular for electrical and mechanical connection to an inner conductor of an electrical cable.

Preferably, the connection area is integrally or monolithically connected to the support area and/or to the contact area.

It can thus be provided that the electrical contact element has the contact area along the longitudinal axis, starting from the front end of the contact area facing the mating contact element, followed by the support area and again followed by the connection area. Optionally, further areas can also be formed between the aforementioned areas or at one of the ends of the electrical contact element.

The connection area is preferably a pressing or crimping section for direct connection to the electrical conductor. The connection area can, for example, have two crimp tabs, which are initially in part bent towards each other in a trough shape in the delivered state and are pressed or crimped into the final state as part of the final assembly on the electrical cable or on the electrical conductor.

However, the connection area can also be a soldering area for soldering to the electrical conductor of the electrical cable, for example. In principle, the connection area can be designed so as to enable any positive-locking, non-positive-locking and/or material-bonded connection to the electrical conductor of the cable.

The invention also relates to a pre-assembled electrical cable comprising an electrical conductor and an electrical contact element electrically and mechanically connected to the electrical conductor according to the above and following embodiments.

The invention is particularly advantageously suitable for use in the automotive sector, in particular for camera solutions or for contacting PCB contact elements or for space-saving contacting of spring contact elements. In principle, however, the invention can be suitable for any application within the entire field of electrical engineering, in particular for use with plug connections.

In principle, the electrical cable can be an electrical cable of any design, which has at least one electrical conductor. In particular, it can be provided that the electrical cable has an electrical conductor that is optionally directly encased by a cable sheath. The electrical conductor can be freed from the cable sheath at its front end section in order to enable direct connection to the electrical contact element, in particular via the aforementioned connection area.

For example, an electrical cable can also be provided whose inner conductor is initially encased in a dielectric, which in turn is surrounded by an outer conductor (for example a cable shielding braid and/or a cable foil), which in turn is encased in the cable sheath. As an alternative to a coaxial cable of this type, a cable with a plurality of inner conductors can also be provided, for example a differential cable or a twisted pair cable. The type of cable actually used is not necessarily relevant within the scope of the invention.

Furthermore, the invention relates to an electrical plug connector comprising at least one pre-assembled electrical cable according to the preceding and following embodiments. Optionally, the plug connector can further comprise an outer conductor contact element, a plug connector housing (preferably an electrically insulating housing) and/or other conventional connector components, such as latching and securing elements for connection to the corresponding mating connector.

The invention relates furthermore to an electrical contact arrangement, comprising the electrical contact element according to the preceding and following embodiments, as well as the corresponding electrical mating contact element, preferably an end-face contact element.

The invention also relates to a manufacturing method for manufacturing an electrical contact element or an electrical cable pre-assembled with the contact element, comprising at least the following method steps:
providing a primarily flat metal component;
stamping and bending the metal component and/or deep-drawing the metal component in order to form a contact area having an end-face contact surface designed for electrical and mechanical contacting with an electrical mating contact element, and a support area which is arranged on a side of the contact area facing away from the end-face contact surface, is integrally connected to the contact area and is designed so as to mechanically support the contact area.

In contrast to the known manufacturing methods for an end-face contact element, it is not necessary to form the end-face contact element from a solid material. This makes it possible to manufacture the end-face contact element particularly cost-effectively. The proposed contact element or the proposed pre-assembled electrical cable can therefore be particularly advantageously suitable for applications where production in large quantities is required, such as in the automotive sector. The proposed combination of the contact area and the support area can provide sufficient stability for the end-face contacting despite simple manufacture.

With the scope of the aforementioned method, one or more holes can optionally be provided in the end-face contact surface.

According to a further, optional method step, it can be provided to bend two support tabs towards each other so that they form two half shells bent towards each other in order to form a sleeve-shaped support area.

According to a further optional method step, it can be provided that the contact area is bent relative to the support area, preferably with a transition angle of at least approximately 90°.

According to a further optional method step, it can be provided that the contact area is connected to the support area via at least one secondary connecting section, preferably by bending the secondary connecting section starting from the contact area in the direction of the support area and, in particular, forming a positive-locking connection to the support area along the longitudinal axis of the contact element.

According to a further optional method step, it can be provided that an electrical cable is provided which has at least one inner conductor. The inner conductor can be freed from a cable sheath at a front end section before or optionally also during the manufacturing method described above. Again optionally, it can be provided that the electrical contact element is connected to the electrical cable, in particular via a connection area, preferably via a crimp connection.

At this point, it should be emphasized that the method steps mentioned do not necessarily have to be carried out in the sequence in which they are first described or mentioned in the description or in the claims. Individual method steps or groups of method steps can therefore be interchangeable, for example, if this is not technically impossible. Method steps can also be combined with each other, divided into separate intermediate steps or supplemented with intermediate steps. The method is also not necessarily exhaustively described with the method steps described and can be supplemented with further method steps, including those not mentioned.

Features which have been described in conjunction with one of the subjects of the invention, given in name by the electrical contact element, the pre-assembled electrical cable, the electrical plug connector, the electrical contact arrangement or the manufacturing method, can also be advantageously implemented for the other subjects of the invention. Similarly, advantages mentioned in conjunction with one of the subjects of the invention can also be understood in relation to the other subjects of the invention.

In addition, reference is made to the fact that terms such as “including”, “comprising” or “having” do not exclude other features or steps. Moreover, the terms “a” or “the” that refer to a single number of steps or features do not exclude a plurality of features or steps-and conversely.

However, it is also possible in one puristic embodiment of the invention to provide that the features that are disclosed in the invention with the terms “including”, “comprising” or “having” are exhaustively listed. Accordingly, one or multiple listings of features can be considered within the scope of the invention as exhaustive, for example can be considered for each claim respectively. The invention can for example comprise exclusively the features mentioned in claim 1.

It is to be mentioned that references such as “first” or “second” etc. are used primarily for reasons of distinguishability between respective device features or method features and are not absolutely intended to indicate that features are mutually dependent or are in relation to one another.

Moreover, it is to be emphasized that the currently described values and parameters include deviations or fluctuations of ±10% or less, preferably ±5% or less, further preferred ±1% or less, and quite particularly preferred ±0.1% or less of the respectively quoted value or parameter insofar as these deviations are not excluded in the case of implementing the invention in practice. The specification of ranges by means of a starting value and an end value also includes all those values and fractions that are included by the respectively quoted range, in particular the start value and the end value and a respective middle value.

The invention also relates to an electrical end-face contact element independent of claim 1, which is formed from a stamped and bent part or from a deep-drawn metal component. The further features of claim 1 and the dependent claims as well as the features described in the present description relate to advantageous embodiments and variants of this end-face contact element and can be combined as desired with the end-face contact element mentioned here. The applicant explicitly reserves the right to claim such an end-face contact element separately.

### BRIEF DESCRIPTION OF THE DRAWINGS

In the following, exemplary embodiments of the invention are described in more detail with reference to the drawings.

The figures each show preferred exemplary embodiments in which individual features of the present invention are illustrated in combination with one another. Features of an exemplary embodiment can also be implemented separately from the other features of the same exemplary embodiment and can accordingly be readily combined by a person skilled in the art to form further expedient combinations and sub-combinations with features of other exemplary embodiments.

In the figures, elements with the same function are labeled with the same reference signs.

In the drawing schematically:

FIG. 1 shows a stamped, initially not yet bent metal sheet, from which an electrical contact element according to a first exemplary embodiment of the invention can be produced;

FIG. 2 shows the electrical contact element according to the first exemplary embodiment after bending the metal component of FIG. 1;

FIG. 3 shows an electrical cable pre-assembled with the electrical contact element of FIG. 2 according to an exemplary embodiment of the invention;

FIG. 4 shows an electrical contact element according to a second exemplary embodiment of the invention, with a primarily square end-face contact surface;

FIG. 5 shows an electrical contact element according to a third exemplary embodiment of the invention, with a primarily square end-face contact surface and a support area that is only in part closed in the circumferential direction;

FIG. 6 shows an electrical contact element according to a fourth exemplary embodiment of the invention, with a welding point between the secondary connection section and the support area;

FIG. 7 shows an electrical contact element according to a fifth exemplary embodiment of the invention, with a locating hole in the end-face contact surface;

FIG. 8 shows an electrical contact element according to a sixth exemplary embodiment of the invention, with a contouring of the end-face contact surface along the circumference

FIG. 9 shows an electrical contact element according to a seventh exemplary embodiment of the invention, with a two-part end-face contact surface;

FIG. 10 shows an electrical contact element according to an eighth exemplary embodiment of the invention, with an additional positive-locking connection between the half shells of the support area for mutual locking of the half shells; and

FIG. 11 shows an electrical contact element according to a ninth exemplary embodiment of the invention, with an elastic support of the contact area.

### DETAILED DESCRIPTION OF THE ENABLING EMBODIMENTS

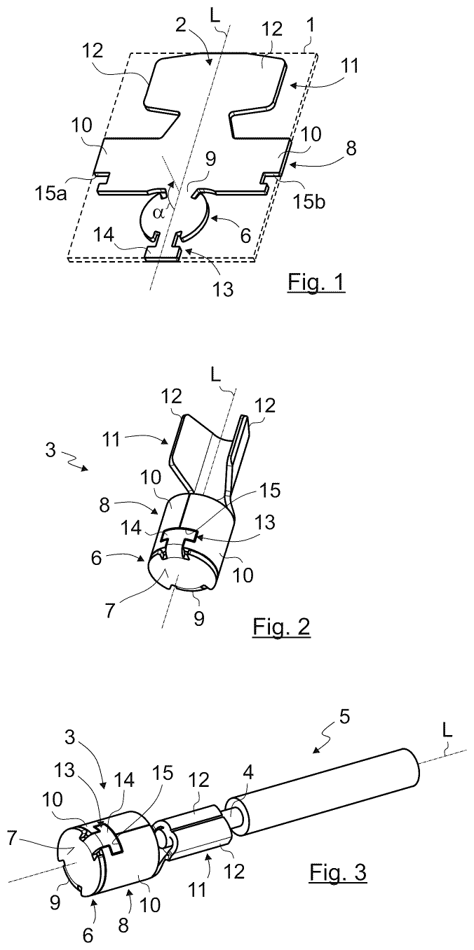

FIG. 1 illustrates in dotted lines a flat metal component 1 or a metal sheet which has been pre-machined by a stamping process to form a blank 2 of an electrical contact element 3 according to a first exemplary embodiment of the invention. In a subsequent bending process, the blank 2 is finally formed into the electrical contact element 3 illustrated in FIG. 2. The electrical contact element 3 is therefore formed from a stamped and bent part in the following figures and embodiments. In principle, however, the electrical contact element 3 can alternatively or additionally be formed from a deep-drawn part or a deep-drawn metal component. The present embodiments are therefore not to be understood as being restrictive.

Finally, FIG. 3 shows the electrical contact element 3 of the first exemplary embodiment of the invention still in a mounted state on an electrical conductor 4 of a correspondingly pre-assembled electrical cable 5.

The electrical contact element 3 of the first exemplary embodiment is described below essentially in conjunction with FIGS. 1 to 3.

The electrical contact element 3 has a contact area 6 having an end-face contact surface 7 designed for electrical and mechanical contacting with an electrical mating contact element (not illustrated). The end-face contact surface 7 is arranged along the longitudinal axis L of the contact element 3 at the front end of the contact element 3, which faces the mating contact element for electrical and mechanical contacting. In the exemplary embodiment, the end-face contact surface 7 is primarily a flat surface, but can also be curved if necessary. The contact area 6 itself is essentially flat or disc-shaped in the exemplary embodiments.

The contact element 3 has a support area 8, which is arranged on a side of the contact area 6 facing away from the end-face contact surface 7. The support area 8 is designed so as to mechanically support the contact area 6 and is connected to the contact area 6 via a primary connecting section 9 integrally to the support area 8 (cf. in particular FIG. 1).

In the exemplary embodiment illustrated in FIGS. 1 to 3, the support area 8 is primarily sleeve-shaped, i.e. preferably at least essentially completely closed along the circumferential direction of the end-face contact surface 7. An annular or in part annular end of the sleeve-shaped support area 8 facing the contact area 6 is thus advantageously able to mechanically support the contact area 6 on the side facing away from the end-face contact surface 7. The sleeve-shaped support area 8 is formed in the exemplary embodiments in each case from two half shells 10 which are bent towards each other.

The end-face contact surface 7 is oriented in the exemplary embodiments orthogonal to the longitudinal axis L of the contact element 3. For this purpose, the primary connecting section 9 is designed as a bending point in order to form a corresponding transition angle α (cf. FIG. 1) between the support area 8 and the contact area 6, preferably a transition angle α of at least approximately 90°, as illustrated.

For connection to the electrical conductor 4, the contact element 3 optionally also has a connection area 11, in the exemplary embodiments a crimping area, which is preferably integrally connected to the support area 8, as illustrated in particular in FIG. 1. The connection area 11 can be formed from two crimping tabs 12, which are bent towards each other in a trough shape in a pre-assembled state (cf. FIG. 2). The later crimped state with the electrical conductor 4 of the cable 5 is illustrated in FIG. 3.

In order to optionally further improve the mechanical stability of the contact element 3, in particular to prevent the end-face contact surface 7 from springing inwards along the longitudinal axis L of the contact element 3, the contact area 6 is connected to the support area 8 via at least one secondary connecting section 13 in the exemplary embodiments. The secondary connecting section 13 is spaced apart from the primary connecting section 9 along the circumference of the end-face contact surface 7, for example along the circumferential direction of the end-face contact surface 7 on the opposite side to the primary connecting section 9, as illustrated in the figures.

The secondary connecting section 13 is integrally connected to the contact area 6 and forms a connecting tab 14, which is bent in the direction of the support area 8 in order to form a positive-locking connection to the support area 8 along the longitudinal axis L of the contact element 3. For this purpose, the connecting tab 14 of the secondary connecting section 13 is essentially T-shaped or has a diameter jump at its free end section in order to engage behind a corresponding recess 15 in the support area 8. In the exemplary embodiments, the recess 15 in the support area 8 is divided into two parts and distributed as a first partial recess 15a and a second partial recess 15b on the respective half shells 10 (cf. FIG. 1).

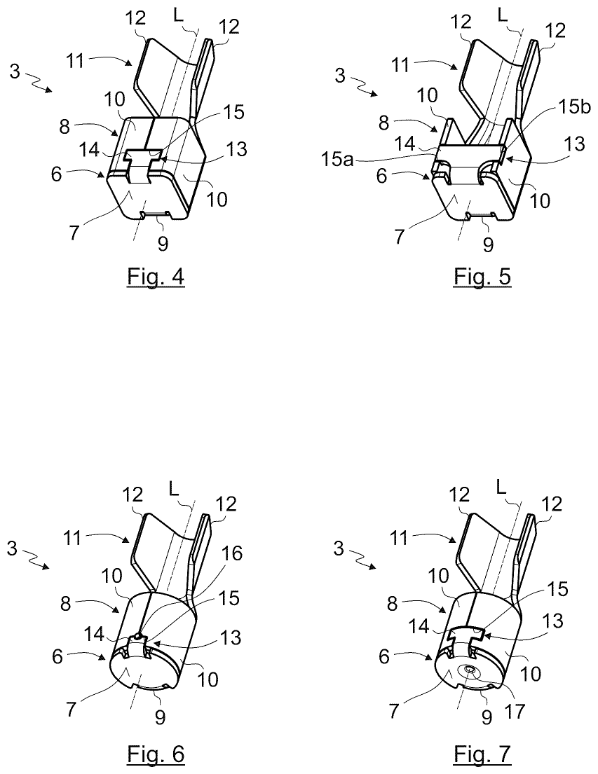

FIGS. 4 to 11 show by way of example further possible exemplary embodiments of an electrical contact element 3 according to the invention, wherein the individual features can also be realized in combination with one another, provided this is not technically impossible.

FIG. 4 is intended to illustrate by way of example that, within the scope of the overall concept according to the invention, basically any geometries can be provided for the contact area 6 or for the end-face contact surface 7. The end-face contact surface 7 therefore does not necessarily have to be round, as illustrated in the first exemplary embodiment example, but can have inter alia a rectangular, square, elliptical or any polygonal cross-section. FIGS. 4 and 5 illustrate an at least approximately square geometry as an example. Accordingly, the support area 8 can also have a corresponding geometry (rectangular/square), wherein however the square contact area 6 in FIG. 4 could also be supported, for example, by a sleeve-shaped support area 8 with a round cross-section, as illustrated in FIG. 2. The geometry of the support area 8 does not necessarily have to correspond to the geometry of the contact area 6—neither in shape nor size or diameter.

FIG. 5 shows by way of example that sufficient support of the contact area 6 can also be provided if the support area 8 is not completely closed in the circumferential direction of the end-face contact surface 7, but is U-shaped, for example. In principle, many different designs of the support area 8 are possible, which can lead to adequate support of the contact area 6. FIG. 5 therefore only serves to illustrate one of many variants.

FIG. 6 illustrates as an example a connection between the secondary connecting section 13 or the connecting tab 14 of the secondary connecting section 13 and the support area 8, in which a material-bonded connection is used as an alternative to the positive-locking connection described above. As an example, a welding point 16 is illustrated in FIG. 6, which, in addition to the connection of the contact area 6 to the support area 8, can also enable the two half shells 10 of the support area 8 to be secured together.

FIG. 7 is intended to illustrate by way of example that one or more holes can be formed in the end-face contact surface 7, for example a central centering hole 17, which can function inter alia as a locating hole. However, is necessary, holes can also be useful for connecting one or more permanent magnets to the contact element 3 (not illustrated), so that contacting with the mating contact element is facilitated, for example in order to enable blind mating, or however also to provide magnetic coding for the connection to a corresponding mating contact element. Mechanical coding means can also be provided if necessary.

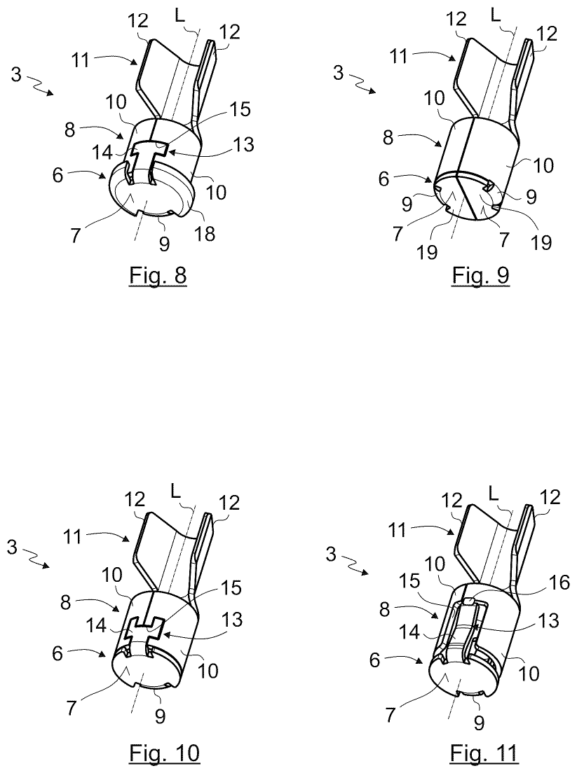

FIG. 8 is intended to illustrate that the contact area 6 or the end-face contact surface 7 can also be contoured if necessary. As an example, FIG. 8 illustrates a rounding 18 along the circumference of the end-face contact surface 7. A chamfer can also be provided if necessary. This can, for example, enable centering in a correspondingly designed mating contact element.

FIG. 8 also illustrates that the diameter of the end-face contact surface 7 does not necessarily have to correspond to the diameter of the support area 8 or of the sleeve-shaped support area 8 in order to provide sufficient support.

In the above example embodiments, the end-face contact surface 7 is designed as a single, continuous surface in each case. However, this is not absolutely necessary, as intended to be clarified with the aid of FIG. 9. In FIG. 9, the end-face contact surface 7 is formed from two contact tabs 19 that are bent towards each other and are each connected integrally or monolithically via a respective primary connecting section 9 to the support area 8 or the respective associated half shells 10 of the support area 8. In principle, a further subdivision of the end-face contact surface 7 can also be provided, although a single, continuous end-face contact surface 7 is generally preferred for reasons of mechanical stability.

In order to additionally prevent the half shells 10 of the sleeve-shaped support area 8 from springing open, a further positive-locking connection in the circumferential direction of the sleeve-shaped support area 8 can also be provided in addition to the variant of a welding or bonding point already presented, which is provided by a correspondingly designed connecting tab 14 of the secondary connecting section 13, as illustrated in FIG. 10. In this way, on the one hand the contact area 6 can be locked against the support area 8 and in addition the two half shells 10 of the support area 8 can each also be locked against each other.

At this point, it should be mentioned that as an alternative to the ‘watchtower-like’ geometry of the connecting tab 14 of the secondary connecting section 13 of FIG. 10, alternative geometries can also be provided in order to enable the double positive-locking connection.

The exemplary embodiments of the invention proposed above each show a rigid or inelastic support of the contact area 6 by the support area 8. Alternatively, however, depending on the application, it can also be possible for the support area 8 to provide elastically cushioning support of the contact area 6 along the longitudinal axis L of the contact element 3. In this way, a spring-loaded end-face contact element can be provided. This can be made possible, for example, by dispensing with the secondary connecting section 13 in order to deliberately allow the contact area 6 to deflect inwards in the direction of the support area 8. In this case, the support area 8 merely forms an end stop for the support and offers the contact area 6 a certain amount of elastic play along the longitudinal axis L in a defined section.

A further variant for elastic support is illustrated in FIG. 11. Here, the connecting tabs 14 of the primary connecting section 9 and of the secondary connecting section 13 are each designed as spring tabs. In this embodiment, the primary connecting section 9 can still be integrally connected to the support area 8 and the contact area 6, wherein the secondary connecting section 13 is preferably optionally connected to the contact area 6 or the support area 8 by an additional welding point 16 or bonding point or by pressing after the blank 2 has been bent into the shape illustrated in FIG. 11.

What is claimed is:

1. An electrical contact element which is formed from a stamped and bent part and/or from a deep-drawn metal component, comprising:
a contact area having an end-face contact surface designed for electrical and mechanical contacting with an electrical mating contact element; and
a support area which is arranged on a side of the contact area facing away from the end-face contact surface and is designed so as to mechanically support the contact area,
wherein the contact area is integrally connected to the support area via a primarily connecting section, and connected to the support area via at least one secondary connecting section which is at a distance from the primary connecting section along the circumference of the end-face contact surface.

2. The electrical contact element according to claim 1, wherein the end-face contact surface is designed as a single, continuous surface.

3. The electrical contact element according to claim 1, wherein the end-face contact surface is a primarily flat surface.

4. The electrical contact element according to claim 1, wherein one or more holes are formed in the end-face contact surface.

5. The electrical contact element according to claim 4, wherein the one or more holes include a central centering hole.

6. The electrical contact element according to claim 1, wherein the support area is primarily sleeve-shaped, and an annular or in part annular end of the sleeve-shaped support area facing the contact area mechanically supports the contact area on the side facing away from the end-face contact surface.

7. The electrical contact element according to claim 6, wherein the sleeve-shaped support area is formed from two half shells which are bent towards each other.

8. The electrical contact element according to claim 1, wherein the primary connecting section is designed as a bending point so as to form a transition angle (α) between the support area and the contact area.

9. The electrical contact element according to claim 8, wherein the transition angle (α) is at least approximately 90°.

10. The electrical contact element according to claim 1, wherein the secondary connecting section is formed integrally with a connecting tab which is connected to the contact area and is bent in the direction of the support area and is connected in a positive-locking manner to the support area along a longitudinal axis of the contact element.

11. The electrical contact element according to claim 10, wherein the connecting tab of the secondary connecting section is connected to the support area at the connection sites of the two half shells and forms a further positive-locking connection in the circumferential direction of the sleeve-shaped support area so that the two half shells of the support area are locked against each other.

12. The electrical contact element according to claim 1, wherein the secondary connecting section has at least one welding point or bonding point in order to connect the contact area to the support area.

13. The electrical contact element according to claim 1, wherein the support area provides an elastic cushioning support of the contact area along a longitudinal axis of the contact element.

14. The electrical contact element according to claim 1, further comprising a connection area for electrical and mechanical connection to an electrical conductor, in particular an inner conductor of an electrical cable which is integrally connected to the support area and/or the contact area.

15. A pre-assembled electrical cable, comprising an electrical conductor and an electrical contact element electrically and mechanically connected to the electrical conductor as claimed in claim 1.

16. A manufacturing method, comprising at least the following method steps:
providing a primarily flat metal component;
stamping and bending the metal component or deep-drawing the metal component in order to form a contact area having an end-face contact surface designed for electrical and mechanical contacting with an electrical mating contact element, and a support area which is arranged on a side of the contact area facing away from the end-face contact surface and is integrally connected to the contact area via a primarily connecting section, and connected to the contact area via at least one secondary connecting section which is at a distance from the primary connecting section along the circumference of the end-face contact surface for mechanically supporting the contact area.

17. An electrical contact element which is formed from a stamped and bent part and/or from a deep-drawn metal component, comprising:
a contact area having an end-face contact surface designed for electrical and mechanical contacting with an electrical mating contact element; and
a support area which is arranged on a side of the contact area facing away from the end-face contact surface and is designed so as to mechanically support the contact area,
wherein the contact area is integrally connected to the support area via a primarily connecting section, and
wherein the support area is primarily sleeve-shaped, and an annular or in part annular end of the sleeve-shaped support area facing the contact area mechanically supports the contact area on a side facing away from the end-face contact surface.
